(19) United States
(12) Patent Application Publication
(10) Pub. No.: US 2025/0096851 A1
(43) Pub. Date: Mar. 20, 2025

(54) BEAM CONFIGURATION TECHNIQUES FOR RECONFIGURABLE INTELLIGENT SURFACE IN WIRELESS COMMUNICATION SYSTEM

(71) Applicant: ELECTRONICS AND TELECOMMUNICATIONS RESEARCH INSTITUTE, Daejeon (KR)

(72) Inventors: NAMSUK LEE, Daejeon (KR); Hee Sang CHUNG, Daejeon (KR)

(21) Appl. No.: 18/770,506

(22) Filed: Jul. 11, 2024

(30) Foreign Application Priority Data
Sep. 19, 2023 (KR) 10-2023-0125139
Nov. 21, 2023 (KR) 10-2023-0161857

(51) Int. Cl. H04B 7/04; H04B 7/06; H04W 16/28; H04W 52/24

(52) U.S. Cl. CPC H04B 7/04013; H04B 7/0617; H04B 7/0626; H04W 16/28; H04W 52/242

(57) ABSTRACT

Various embodiments for beam configuration in a wireless communication system are disclosed. In one embodiment, a method for configuring a beam by a base station may include determining a beam parameter including at least one of a beam width, a beam aiming direction, and a beam transmission power of a beam based on at least one of a location and an area of a reflective surface; generating beam configuration information including at least one beam based on the determined beam parameter and transmitting the beam configuration information to a controller that controls the reflecting surface; forming the at least one beam according to the beam parameter and the beam configuration information; receiving beam quality information from the controller; and adjusting beamforming based on the received beam quality information.

### CROSS REFERENCE TO RELATED APPLICATION

The present application claims priority to Korean Patent Application No. 10-2023-0125139, filed on Sep. 19, 2023, No. 10-2023-0161857, filed on Nov. 21, 2023, the entire contents of which are incorporated herein for all purposes by this reference.

### BACKGROUND

### Technical Field

This disclosure relates to beam configuration technology in wireless communication systems, and more specifically, some embodiments relate to a technology in which a base station configures beams for a reconfigurable intelligent surface in a wireless communication system.

### Description of the Related Art

Future 6G wireless communication systems beyond 5G must satisfy wireless requirements of terabit per second (Tbps) and ultra-low latency. To achieve this, systems operating in the millimeter-wave and terahertz bands must be implemented. Frequencies in the millimeter-wave and terahertz bands have strong rectilinear propagation characteristics and diffraction and scattering phenomena do not occur easily. In addition, the propagation distance is short due to severe path loss and atmospheric loss. To overcome this, beamforming technology is used.

Beamforming technology can transmit beams in a desired direction and concentrate transmit power in the beam direction, enabling the provision of wireless services to distant user equipment (UE).

Beams transmitted in the millimeter-wave and terahertz bands as described above may not be delivered due to obstacles, resulting in the creation of multiple shadow areas within a cell. As a solution to this problem, research on Reconfigurable Intelligent Surfaces (RIS) is being conducted. RIS can reflect beams received from a base station and provide the reflected beams to UEs located in shadow areas. However, current RIS-based beamforming technologies have limitations in terms of received signal quality, base station system capacity, or other aspects, necessitating further improvements.

### SUMMARY

Therefore, a beam configuration technique for a reflective surface (e.g., RIS) in a wireless communication system that is superior in terms of received signal quality, base station system capacity, or other aspects (for example, the received signal quality of the reflected beam for a terminal located in a shadow area can be improved, or the base station system capacity can be increased) may be needed.

One aspect of this disclosure provides a method of configuring a beam by a base station. The method may comprise determining a beam parameter including at least one of beamwidth, beam steering direction, and beam transmission power, based on at least one of a location and an area of a reflective surface;
generating beam configuration information including at least one beam based on the determined beam parameter and transmitting the beam configuration information to a controller controlling the reflective surface;
forming the at least one beam according to the beam parameter and the beam configuration information;
receiving beam quality information from the controller, the beam quality information including a beam index for each of the formed at least one beam and signal quality information of a reflected beam obtained by reflecting the corresponding beam by the reflective surface; and
adjusting beam formation based on the received beam quality information.

In some embodiments, determining step may comprise: receiving reflective surface information including information on the location and the area of the reflective surface from the controller; and determining the beam parameter based on the received reflective surface information.

In some embodiments, the determining step may comprise estimating a distance between the base station and the reflective surface based on the location of the reflective surface; and
determining the beamwidth, the beam steering direction, and the beam transmission power based on at least a part of the estimated distance, the location of the reflective surface, and the area of the reflective surface.

In some embodiments, the beam may include a Synchronization Signal Block (SSB) beam, the forming step may include performing SSB beam sweeping, and
the beam index may include an SSB index.

In some embodiments, the beam quality information may include signal quality information of reflected beams corresponding to a plurality of SSB beams, respectively, and the adjusting step may comprise: selecting at least one of the plurality of SSB beams based on the beam quality information; and adjusting the beam parameters based on the selected at least one SSB beam.

In some embodiments, the beam may include a Channel State Information—Reference Signal (CSI-RS) beam, and
the beam index may include a CSI-RS index.

In some embodiments, the beam quality information may include signal quality information of reflected beams corresponding to a plurality of CSI-RS beams, respectively, and the adjusting step may comprise: selecting at least one of the plurality of CSI-RS beams based on the beam quality information; and
adjusting the beam parameters for an SSB beam including the selected at least one CSI-RS beam.

In some embodiments, the method may further comprise forming the SSB beam including the selected at least one CSI-RS beam according to the adjusted beam parameters; receiving feedback information on the selected at least one CSI-RS beam from a user equipment; and selecting one of the selected at least one CSI-RS beam based on the received feedback information.

In some embodiments, the user equipment may comprise a user equipment that has initially accessed the base station based on the SSB beam including the selected at least one CSI-RS beam.

In some embodiments, the reflective surface may comprise a Reflective Intelligent Surface.

Another aspect of this disclosure provides a method for controlling a reflective surface that reflects a beam formed by a base station. The method may comprise receiving beam configuration information from the base station; transmitting the beam configuration information to a signal measuring device; Receiving beam quality information from the signal measuring device, the beam quality information including a beam index for each beam formed by the base station and signal quality information of a reflected beam obtained by reflecting the corresponding beam by the reflective surface; and transmitting the received beam quality information to the base station.

In some embodiments, the method may further comprise transmitting reflective surface information including information on a location and an area of the reflective surface to the base station.

In some embodiments, the method may further comprise setting an initial angle of incidence of the reflective surface based on the received beam configuration information.

In some embodiments, the method may further comprise instructing the signal measuring device to measure beam quality; and adjusting the angle of incidence of the reflective surface based on the received beam quality information, and the receiving step includes storing the received beam quality information in association with a currently set angle of incidence, and the instructing step, the receiving step, and the adjusting step are repeated until beam quality information for a plurality of angles of incidence is obtained.

In some embodiments, the instructing step, the receiving step, and the adjusting step are repeated until beam quality information for all settable angles of incidence of the reflective surface is obtained.

In some embodiments, the method may further comprise selecting one of the plurality of angles of incidence based on the obtained beam quality information for each of the plurality of angles of incidence, and setting the angle of incidence of the reflective surface to the selected angle of incidence; and transmitting the beam quality information associated with the selected angle of incidence to the base station.

In some embodiments, the beam may include an SSB beam, the beam is formed by SSB beam sweeping, and the beam index includes an SSB index.

In some embodiments, the beam may include a Channel State Information-Reference Signal (CSI-RS) beam, and the beam index includes a CSI-RS index.

Another aspect of this disclosure provides a base station comprising: A processor; one or more hardware-based transceivers; and a computer-readable storage medium containing instructions, which, in response to execution by the processor, cause the base station to perform at least one embodiment of the method of this disclosure.

Another aspect of this disclosure provides a controller for controlling a reflective surface that reflects a beam formed by a base station, comprising: a processor; one or more hardware-based transceivers; and a computer-readable storage medium containing instructions, which, in response to execution by the processor, cause the controller to perform at least one embodiment of the method of this disclosure.

Another aspect of this disclosure provides a non-transitory recording medium storing instructions readable by a processor of an electronic device, wherein the instructions cause the processor to perform embodiments of this disclosure.

This summary is provided to introduce a selection of concepts in a simplified form that are further described in the detailed description below. This summary is not intended to identify key or essential features of the claimed subject matter, nor is it intended to be used to limit the scope of the claimed subject matter. The claimed subject matter is not limited to implementations that solve any or all disadvantages noted in any part of this disclosure. In addition to the exemplary aspects, embodiments, and features described above, further aspects, embodiments, and features will become apparent from the following detailed description and accompanying drawings.

Some embodiments of this disclosure may have an effect including the following advantages. However, since it is not meant that all exemplary embodiments should include all of them, the scope of the present disclosure should not be understood as being limited thereto.

According to some embodiments, the signal quality of a user equipment (UE) located in a shadow area may be improved. According to some embodiments, the system capacity of the base station may be increased.

### BRIEF DESCRIPTION OF THE DRAWINGS

FIG. 1 and FIG. 2 are diagrams illustrating SSB-based beamforming and CSI-RS-based beamforming.

FIG. 3 is a diagram illustrating a wireless communication system.

FIG. 4 is a diagram illustrating a wireless communication system to describe some embodiments of the beam configuration of the present disclosure.

FIG. 5 is a flowchart for describing some embodiments of the beam configuration of the present disclosure.

FIG. 6 is a flowchart for describing some embodiments of the reflecting surface control of the present disclosure.

FIG. 7A and FIG. 7B are diagrams for describing some embodiments of the SSB beam-based beam configuration.

FIG. 8A and FIG. 8B are diagrams for describing some embodiments of the CSI-RS beam-based beam configuration.

FIG. 9 is a flowchart for describing some embodiments of the operation of the RIS controller in the SSB beam-based beam configuration.

FIG. 10 is a flowchart for describing some embodiments of the operation of the base station in the SSB beam-based beam configuration.

FIG. 11 is a flowchart for describing some embodiments of the operation of the RIS controller in the CSI-RS beam-based beam configuration.

FIG. 12 is a flowchart for describing some embodiments of the operation of the base station in the CSI-RS beam-based beam configuration.

FIG. 13 is a block diagram illustrating an electronic device for performing a method according to embodiments of the present disclosure.

### DETAILED DESCRIPTION OF THE DISCLOSURE

Since the description of the present disclosure is merely an exemplary embodiment for structural or functional description, the scope of the present disclosure should not be construed as being limited by the exemplary embodiments described in the text. That is, since exemplary embodiments may be changed in various ways and may have various forms, it should be understood that the right scope of the present disclosure includes equivalents that can realize the technical idea. In addition, the objectives or effects presented in the present disclosure may not mean that a specific exemplary embodiment should include all or only such effects, so the right scope of the present disclosure should not be understood as being limited thereto.

Meanwhile, the meaning of the terms described in the present disclosure should be understood as follows.

Terms such as “first”, “second”, and the like are intended to distinguish one component from another component, and the scope of rights should not be limited by these terms. For example, a first component may be referred to as a second component, and similarly, a second component may also be referred to as a first component.

When a component is referred to as being “connected” to another component, it may be directly connected to the other component, but it should be understood that other components may exist in the middle. On the other hand, when a component is referred to as being “directly connected” to another component, it should be understood that no other component exists in the middle. Meanwhile, other expressions describing the relationship between components, such as “between” and “immediately between” or “neighboring to” and “directly neighboring to”, should be interpreted in the same way.

Singular expressions should be understood to include plural expressions unless the context clearly indicates otherwise, and terms such as “include” or “have” are intended to designate the existence of features, numbers, steps, actions, components, parts, or combinations thereof, and should be understood not to preclude the possibilities of the existence or addition of one or more other features or numbers, steps, actions, components, parts, or combinations thereof.

In each step, identification codes (e.g., a, b, c, etc.) may be used for the convenience of explanation, and identification codes may not describe the order of each step, and each step may occur differently from the specified order unless a specific order is explicitly stated in the context. That is, each step may occur in the same order as the specified order, may be performed substantially simultaneously, or may be performed in the opposite order.

In 5G NR, beam transmission and beam management are classified into SSB-based beamforming and CSI-RS-based beamforming.

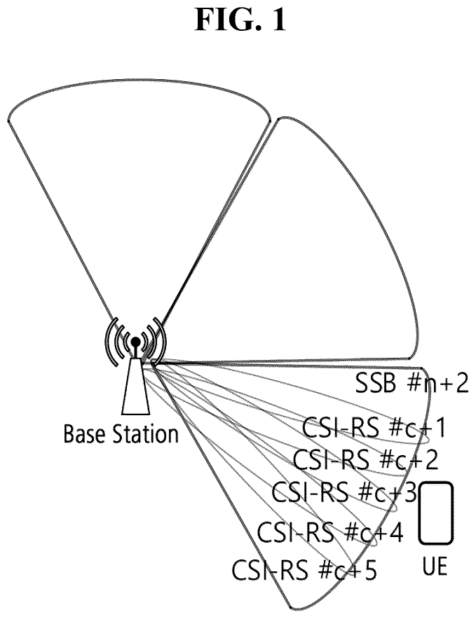

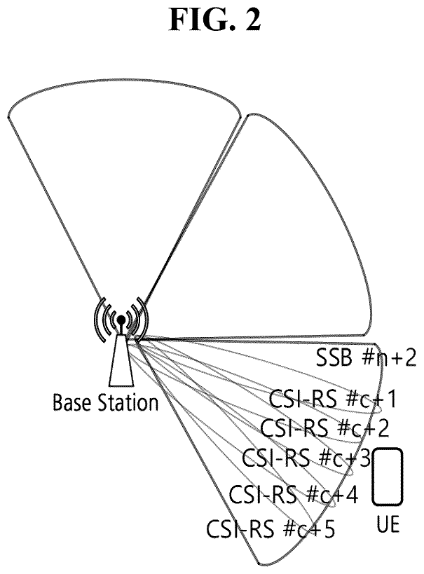

FIG. 1 and FIG. 2 are diagrams illustrating SSB-based beamforming and CSI-RS-based beamforming.

SSB is transmitted with a wide beam width. The SSB beam is transmitted with a transmission cycle for all areas of the cell. That is, as shown in FIG. 1, beam sweeping is performed by periodically transmitting a specific SSB beam to a specific cell area in a specific time zone in the time domain and transmitting different SSB beams in different time zones to transmit multiple SSB beams for all areas of the cell.

The SSB beam transmits information for acquiring synchronization signals and system information. A User Equipment (UE) selects the optimal SSB beam for initial access, performs downlink synchronization, acquires system information, and then performs an initial access procedure.

The UE selects an SSB beam with a wide beam width to perform initial access. In order to improve the signal quality of the UE, the base station transmits CSI-RS configuration information to the UE, receives feedback information on this, and selects the optimal CSI-RS beam.

As shown in FIG. 2, the CSI-RS beam is transmitted with a narrow beam width, so the transmission power can be concentrated more than the SSB.

The UE measures the received signal quality of each CSI-RS beam, such as RSRP, RSRQ, RSSI, based on the CSI-RS configuration information, and feeds back this information to the base station. The base station selects the optimal CSI-RS beam and transmits data.

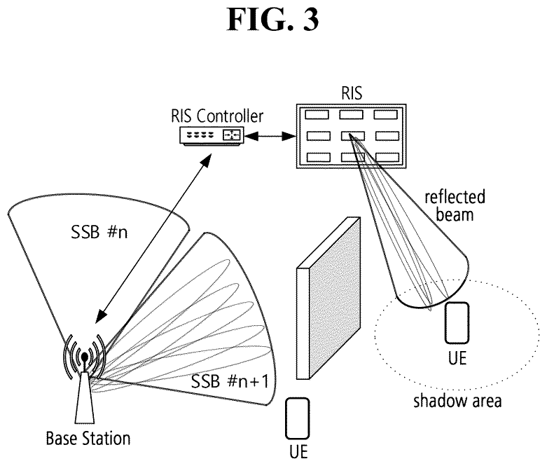

FIG. 3 is a diagram illustrating a wireless communication system.

In the wireless communication system illustrated in FIG. 3, the base station can form beams, and the RIS can reflect the formed beams.

The RIS controller may communicate with the base station and control the RIS.

The UE illustrated in FIG. 3 may be located in a shadowed area where it can substantially receive only reflected beams due to a specific obstacle.

The RIS may form a reflected beam by adjusting the phase and/or amplitude of the reflecting elements constituting the RIS and may reflect the beam incident on the RIS in a desired direction.

Using the reflected beam of the RIS, it may be possible to provide service to a UE located in a shadowed area within a cell. According to the conventional technology, the RIS cannot selectively reflect beams with good signal quality among the beams received from the base station and reflects all the received beams.

In addition, the base station configures and transmits beams considering the cell area in line of sight without considering the RIS, and the RIS reflects the beams formed in this way. Therefore, in such a system, there is a possibility that the signal quality of the reflected beam received at a UE located in the shadowed area may be poor, and even if the RIS is used, there may be a limit to increasing the base station system capacity.

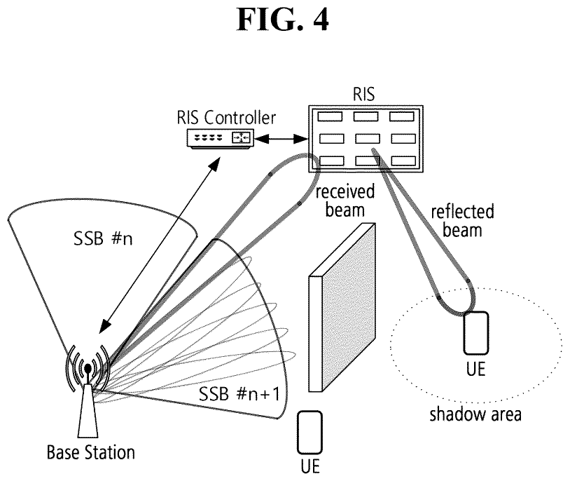

FIG. 4 is a diagram illustrating a wireless communication system to describe some embodiments of the beam configuration of the present disclosure.

Referring to FIG. 4, in some embodiments, based on the location and area information of the RIS, the base station can form and transmit a beam aimed at the RIS using a narrower beam width and transmission power than the general SSB beam or CSI-RS beam.

By forming and transmitting a more narrowly aimed beam for the RIS in this way, the received beam signal quality of the RIS, such as RSRP, RSRQ, RSSI, etc., can be increased, thereby increasing the received signal quality, such as RSRP, RSRQ, RSSI, etc., of the reflected beam received by the UE.

In addition, by forming a more narrowly aimed beam for the RIS, the base station can reduce the interference between the existing SSB beam and CSI-RS beam and the beam formed for the RIS. Furthermore, when the RIS receives the SSB beam and CSI-RS beam generally transmitted by the base station as received beams, forms reflected beams, and provides service to the shadowed area, in the system of FIG. 3, there is an effect of extending the service area of the SSB beam and CSI-RS beam to the shadowed area, but there may be no effect of increasing the system capacity. On the other hand, in the case of forming a separate aimed beam having a narrow beam width for the RIS to service the shadowed area as in the system of FIG. 4, the system capacity of the base station may be increased by creating a separate service beam area for the shadowed area different from the service area of the existing SSB beam and CSI-RS beam.

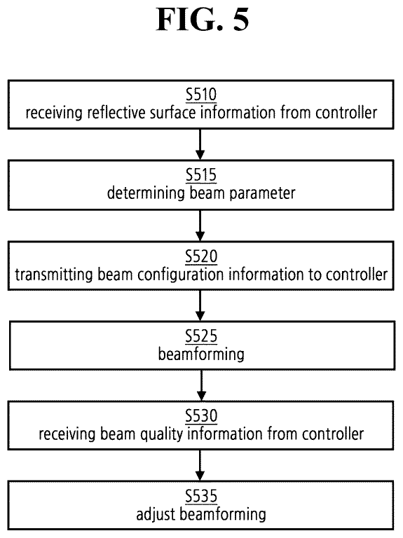

FIG. 5 is a flowchart for describing some embodiments of the beam configuration of the present disclosure.

The operation of FIG. 5 may be performed by a base station (e.g., the base station shown in FIG. 4). In some embodiments, the base station may include a processor, one or more hardware-based transceivers, and a computer-readable storage medium including instructions. In some embodiments, the instructions, in response to execution by the processor, may cause the base station to perform at least one of the embodiments of the beam configuration method of the present disclosure.

In some embodiments, as illustrated in FIG. 5, the base station may determine a beam parameter including at least one of beamwidth, beam steering direction, and beam transmission power, based on at least one of a location and an area of a reflective surface (e.g., the RIS shown in FIG. 4) (S515).

In some embodiments, as illustrated in FIG. 5, the base station may receive reflective surface information from the controller (S510) and determine the beam parameter based on the received reflective surface information (S515).

In some other embodiments, unlike what is illustrated in FIG. 5, the base station may determine the beam parameters without receiving reflective surface information from the controller (S515). For example, the base station may determine the beam parameters based on reflective surface information obtained through another path or set by a network operator.

In some embodiments, the reflective surface information may include information on the location and the area of the reflective surface.

In some embodiments, the beam may include an SSB (Synchronization Signal Block) beam. In some embodiments, the beam may include a CSI-RS (Channel State Information-Reference Signal) beam.

In some embodiments, the base station may estimate a distance between the base station and the reflective surface based on the location of the reflective surface and then determine the beamwidth, the beam steering direction, and the beam transmission power based on at least a part of the estimated distance, the location of the reflective surface, and the area of the reflective surface.

In some embodiments, as illustrated in FIG. 5, the base station may generate beam configuration information including at least one beam based on the determined beam parameter and transmit the beam configuration information to a controller (e.g., the RIS controller illustrated in FIG. 4) that controls the reflective surface (S520).

In some embodiments, as illustrated in FIG. 5, the base station may form at least one beam according to the beam parameter and the beam configuration information (S525). For example, if the beam is an SSB beam, the base station may perform SSB beam sweeping.

In some embodiments, as illustrated in FIG. 5, the base station may receive beam quality information from the controller (S530). In some embodiments, the beam quality information may include a beam index for each of the formed at least one beam and signal quality information of a reflected beam obtained by reflecting the corresponding beam by the reflective surface. In some embodiments, the beam quality information may include a beam index (e.g., an SSB index) for each of a plurality of SSB beams and signal quality information of the reflected beam corresponding to each of the plurality of SSB beams. In some embodiments, the beam quality information may include a beam index (e.g., a CSI-RS index) for each of a plurality of CSI-RS beams and signal quality information of the reflected beam corresponding to each of the plurality of CSI-RS beams.

In some embodiments, as illustrated in FIG. 5, the base station may adjust beam formation based on the received beam quality information (S535).

In some embodiments, the base station may
select at least one of the plurality of SSB beams based on the beam quality information, and adjust the beam parameters for the selected at least one SSB beam. In some embodiments, the base station may select at least one of the plurality of CSI-RS beams based on the beam quality information and adjust the beam parameters for the SSB beam including the selected at least one CSI-RS beam.

In some embodiments, the base station may form the SSB beam including the selected at least one CSI-RS beam according to the adjusted beam parameters.

In some embodiments, the base station may receive feedback information on the selected at least one CSI-RS beam from a UE. In some embodiments, the UE may comprise a user equipment that has initially accessed the base station based on the SSB beam including the selected at least one CSI-RS beam.

In some embodiments, the base station may select one of the selected at least one CSI-RS beam based on the received feedback information.

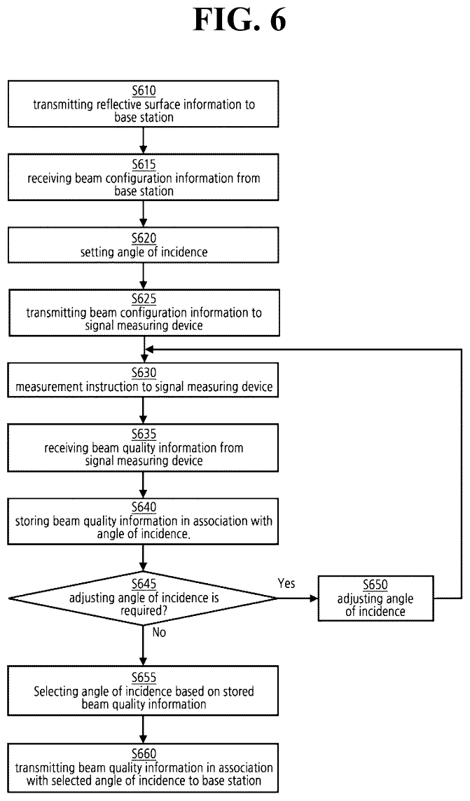

FIG. 6 is a flowchart for describing some embodiments of the reflecting surface control of the present disclosure.

The operation of FIG. 6 may be performed by a controller (e.g., the RIS controller shown in FIG. 4) that controls the reflective surface.

In some embodiments, the controller may include a processor, one or more hardware-based transceivers, and a computer-readable storage medium including instructions. In some embodiments, the instructions, in response to execution by the processor, may cause the controller to perform at least one of the embodiments of the reflecting surface control method of the present disclosure.

In some embodiments, as illustrated in FIG. 6, the controller may transmit reflective surface information including information on a location and an area of the reflective surface to the base station (S610).

In some embodiments, as illustrated in FIG. 6, the controller may receive beam configuration information from the base station (S615).

In some embodiments, as illustrated in FIG. 6, the controller may set an initial angle of incidence of the reflective surface based on the received beam configuration information (S620). For example, if the angle of incidence of the reflecting surface can be adjusted, the controller may perform operation S630.

In some embodiments, the angle of incidence may include the incident angle of the received beam.

In some embodiments, as illustrated in FIG. 6, the controller may transmit the beam configuration information to a signal measuring device (S625).

In some embodiments, the signal measuring device may be a device that measures the signal quality of the reflected beam reflected by the RIS. In some embodiments, the signal quality may be an indicator that can measure the quality of the received signal, for example, RSRP, RSRQ, RSSI, etc.

In some embodiments, as illustrated in FIG. 6, the controller may instruct the signal measuring device to measure beam quality (S630).

In some embodiments, unlike what is illustrated in FIG. 6, operations S625 and S630 may be performed simultaneously.

In some embodiments, unlike what is illustrated in FIG. 6, operation S630 may be performed before operation S625.

In some embodiments, as illustrated in FIG. 6, the controller may receive beam quality information from the signal measuring device (S635).

In some embodiments, the beam quality information may include a beam index for each beam formed by the base station and signal quality information of a reflected beam obtained by reflecting the corresponding beam by the reflective surface.

In some embodiments, as illustrated in FIG. 6, the controller may store the received beam quality information in association with a currently set angle of incidence (S640).

In some embodiments, as illustrated in FIG. 6, the controller may determine whether processing corresponding to another angle of incidence is required (S645). For example, some of the above operations (e.g., S630, S635, S640) may be set to be repeated until beam quality information for all settable angles of incidence is obtained, or until beam quality information for each of a predetermined plurality of angles of incidence is obtained.

In some embodiments, as illustrated in FIG. 6, if it is determined that processing corresponding to another angle of incidence is required (S645), the controller may adjust the angle of incidence of the reflective surface based on the received beam quality information (S650).

In some embodiments, after performing operation S650, the process may proceed to S630 to start the process of obtaining quality information for the corresponding angle of incidence.

In some embodiments, as illustrated in FIG. 6, if it is determined that processing corresponding to another angle of incidence is not required (S645), the controller may select one of the at least one angle of incidence based on the beam quality information for each of the at least of angle of incidence obtained so far, and set the angle of incidence of the reflective surface to the selected angle of incidence (S655).

In some embodiments, as illustrated in FIG. 6, the controller may transmit the beam quality information associated with the selected angle of incidence to the base station (S660).

In some embodiments, some of the above operations may be omitted. For example, if the angle of incidence of the reflecting surface is fixed and cannot be adjusted, S620, S640, S645, S650, and S655 may be omitted, and the controller may transmit the beam quality information corresponding to the fixed angle of incidence to the base station in S660.

Embodiments in which the base station forms an aimed beam with a narrow beam width for the RIS can be classified into SSB beam-based embodiments and CSI-RS beam-based embodiments.

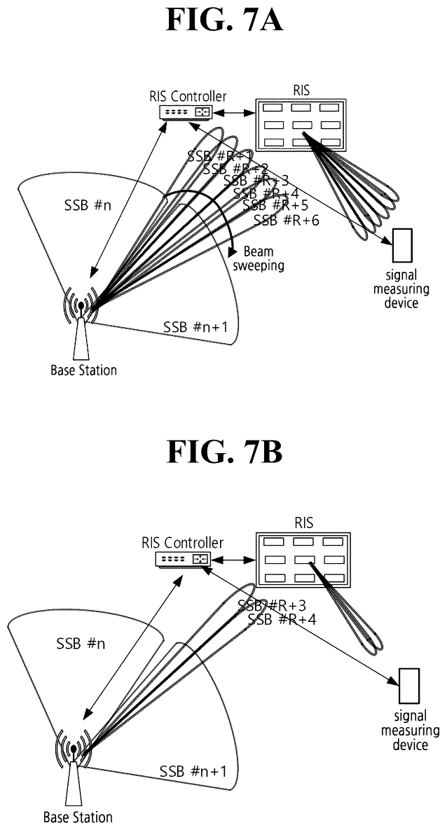

FIG. 7a and FIG. 7b are diagrams for describing some embodiments of the SSB beam-based beam configuration.

In some embodiments, as illustrated in FIG. 7a, the RIS controller may communicate with the base station.

In some embodiments, the RIS controller may adjust the direction of the reflected beam by adjusting the phase and/or amplitude of the reflecting elements of the RIS.

In some embodiments, the RIS controller can generate multiple reflected beams for multiple beams transmitted from the base station.

In some embodiments, the RIS controller may adjust the angle of incidence of the received beam.

In some embodiments, the RIS controller may initially transmit the location and area information of the RIS to the base station.

In some embodiments, the base station may calculate the distance between the base station and the RIS based on the location and area information of the RIS.

In some embodiments, the base station can determine the beam width, beam steering direction, and beam transmission power for the RIS based on the calculated distance and RIS area.

In some embodiments, the base station may configure a plurality of SSB beams (e.g., SSB #n, SSB #n+1, SSB #R+1, SSB #R+2, SSB #R+3, SSB #R+4, etc. shown in FIG. 7) based on the beam width, beam steering direction, and beam transmission power. In some embodiments, the base station may use an array antenna or a parabolic antenna to form a focused beam with a narrow beam width.

In some embodiments, the base station may start beam sweeping by transmitting SSB beams (e.g., SSB #n, SSB #n+1, SSB #R+1, etc. shown in FIG. 7) at different times in the time domain.

In some embodiments, the base station may transmit SSB beam configuration information to the RIS controller.

In some embodiments, the RIS controller may transmit the SSB beam configuration information received from the base station to the signal measuring device and select and set the angle of incidence for the SSB beam received from the base station.

In some embodiments, the signal measuring device may receive the configuration information of the SSB beams from the RIS controller and measure the quality of the reflected beam reception signal for each SSB beam received at different time slots in the time domain.

In some embodiments, the signal measuring device may store the received SSB beam's SSB index and received signal quality.

In some embodiments, the signal measuring device may transmit the stored SSB index and received signal quality information to the RIS controller.

In some embodiments, the RIS controller may store the SSB index and signal quality information received from the signal measuring device in association with the currently set angle of incidence.

In some embodiments, if further adjustment of the incidence angle is possible, the RIS controller may select and set the angle of incidence and then instruct the signal measuring device to measure the signal quality of the reflected beam.

In some embodiments, the RIS controller may store the SSB index and signal quality information received from the signal measuring device in association with the currently set angle of incidence. This process may be used to select the optimal angle of incidence in some embodiments.

In some embodiments, the RIS controller may measure the signal quality for each SSB for all measurable angles of incidence through the signal measuring device, and then determine the angle of incidence associated with the SSB beams with the best signal quality.

In some embodiments, the RIS controller may set the angle of incidence of the RIS to the determined angle of incidence.

In some embodiments, the RIS controller may transmit the signal quality information of each SSB associated with the set angle of incidence to the base station.

In some embodiments, the base station may select the optimal SSB beam (e.g., SSB #R+3, SSB #R+4 shown in FIG. 7b) for the RIS based on this quality information.

The base station may additionally adjust the beam width, steering direction, and beam transmission power based on the selected SSB beam.

Through this process, the optimal SSB beams for the RIS may be selected as shown in FIG. 7b, and beam sweeping for the selected SSB beams may be performed.

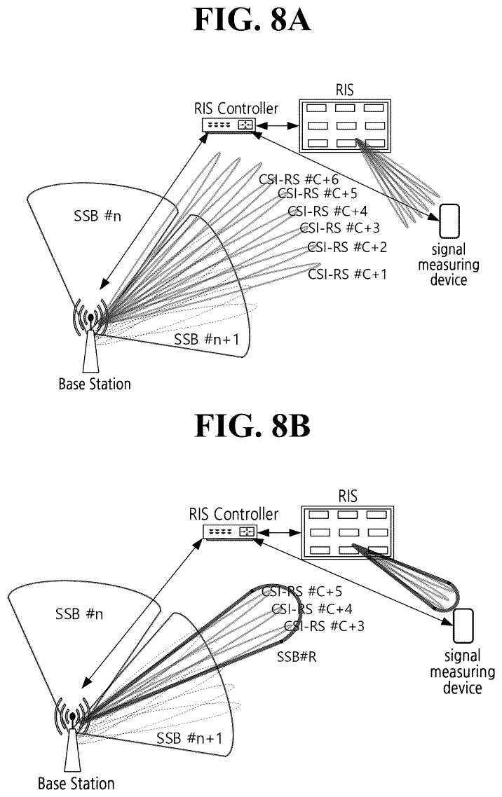

FIG. 8a and FIG. 8b are diagrams for describing some embodiments of the CSI-RS beam-based beam configuration.

Referring to FIG. 8a, in some embodiments, the RIS controller may initially transmit the location and area information of the RIS to the base station.

In some embodiments, the base station may calculate the distance between the base station and the RIS based on the location and area information of the RIS.

In some embodiments, the base station may determine the beam width, beam steering direction, and beam transmission power for the RIS based on the calculated distance and RIS area.

In some embodiments, the base station may configure a plurality of CSI-RS beams (e.g., CSI-RS #C+1, CSI-RS #C+2, etc. shown in FIG. 8a) in the direction where the RIS is located based on the determined result.

In some embodiments, the base station may use an array antenna or a parabolic antenna to form a focused beam with a narrow beam width.

In some embodiments, the base station may simultaneously configure a plurality of CSI-RS beams in different time and frequency domains.

In some embodiments, the base station may transmit CSI-RS beam configuration information to the RIS controller and start transmitting a plurality of CSI-RS beams.

In some embodiments, the RIS controller may select and set the angle of incidence based on the CSI-RS beam configuration information received from the base station, and instruct the signal measuring device to measure the signal quality of the reflected beam by transmitting the received CSI-RS beam configuration information to the signal measuring device.

In some embodiments, the signal measuring device may measure the signal quality of the reflected beam reflected from the RIS by receiving the CSI-RS beam configuration information.

In some embodiments, the signal measuring device may measure and store RSRP, RSRQ, RSSI, etc. for each CSI-RS index.

In some embodiments, when the measurement is completed, the signal measuring device may transmit the measured signal quality information for each CSI-RS index to the RIS controller.

In some embodiments, the RIS controller may receive the signal quality information for each CSI-RS index from the signal measuring device and store it in association with the currently set angle of incidence.

In some embodiments, if an additional angle of incidence can be set, the RIS controller may newly set the angle of incidence and then instruct the signal measuring device to measure the received quality of the reflected beam.

In some embodiments, when signal quality information for all settable angles of incidence is collected, the RIS controller may determine the optimal angle of incidence based on the CSI-RS signal quality information of each angle of incidence and set the angle of incidence.

In some embodiments, the RIS controller may transmit the signal quality information for each CSI-RS index associated with the angle of incidence to the base station.

In some embodiments, when the base station receives the signal quality information for each CSI-RS index from the RIS controller, it may select the optimal one or more CSI-RS indices (e.g., CSI-RS #C+3, CSI-RS #C+4, CSI-RS #C+5 shown in FIG. 8b).

In some embodiments, the base station may calculate the beamwidth, transmission power, etc., to configure the SSB beam that includes the selected CSI-RS beam (e.g., SSB #n+1 shown in FIG. 8b).

In some embodiments, the base station may start transmitting the newly configured SSB beam to the RIS.

In some embodiments, when the UE performs initial access using this SSB beam, the base station can transmit the selected CSI-RS beams and receive feedback information about the CSI-RS beams from the UE.

In some embodiments, the base station may select the optimal CSI-RS beam based on the received feedback information.

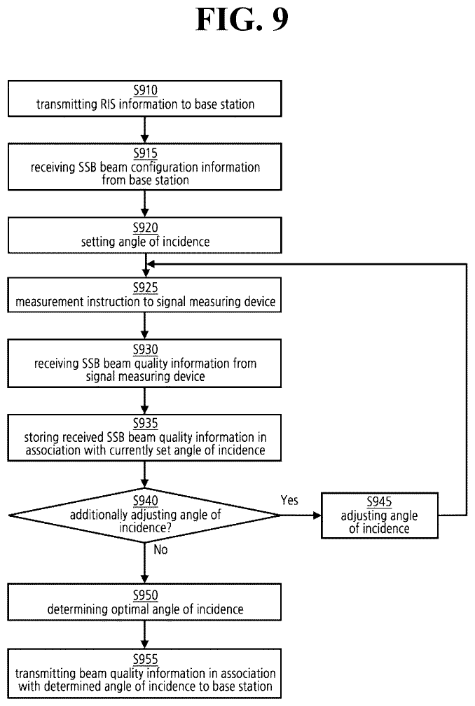

FIG. 9 is a flowchart for describing some embodiments of the operation of the RIS controller in the SSB beam-based beam configuration.

In some embodiments, as illustrated in FIG. 9, the RIS controller may transmit RIS information to the base station (S910). In some embodiments, the RIS information may include at least one of the location information and the area information of the RIS.

In some embodiments, as illustrated in FIG. 9, the RIS controller may receive SSB beam configuration information from the base station (S915).

In some embodiments, as illustrated in FIG. 9, the RIS controller may determine and set an initial angle of incidence of the received beam based on the received SSB beam configuration information (S920). In some embodiments, the angle of incidence of the received beam may be set through direction control of the RIS and/or phase control of the reflecting elements of the RIS.

In some embodiments, as illustrated in FIG. 9, the RIS controller may transmit the SSB beam configuration information to the signal measuring device and instruct the signal measuring device to measure the signal quality of the reflected beam (S925). In some embodiments, the signal measuring device may measure and transmit the received signal quality of the reflected beam for each SSB index to the RIS controller based on the SSB beam configuration information.

In some embodiments, as illustrated in FIG. 9, the RIS controller may receive SSB beam quality information from the signal measuring device (S930). In some embodiments, the SSB beam quality information may include an SSB index of each SSB beam sweeping in the time domain, and signal quality information corresponding to the beam (i.e., the quality information of the signal that is reflected by the RIS and received by the signal measuring device, such as RSRP, RSRQ, RSSI).

In some embodiments, as illustrated in FIG. 9, the RIS controller may store the received SSB beam quality information (e.g., signal quality information for each SSB index) in association with the currently set angle of incidence (S935).

In some embodiments, as illustrated in FIG. 9, if additional angle of incidence adjustment should be performed (e.g., in a structure capable of adjusting the angle of incidence, the preset number of angle of incidence adjustments has not been reached or measurement for all angles of incidence has not been performed) (S940), the RIS controller may additionally adjust and set the angle of incidence (S945) and repeat operations S925, S930, and S935.

In some embodiments, as illustrated in FIG. 9, if further adjustment of the angle of arrival does not need to be performed (S940), the RIS controller may determine the optimal angle of incidence based on the SSB beam quality information obtained so far (S950). For example, when quality measurement for the SSB beam for all angles of incidence is completed, the RIS controller may determine the optimal angle of incidence based on the stored SSB beam quality information for each angle of incidence (e.g., received signal quality information for the reflected beam obtained by reflecting at least one of the SSB beams according to the corresponding angle of incidence).

In some embodiments, as illustrated in FIG. 9, the RIS controller may transmit the SSB beam quality information associated with the determined angle of incidence to the base station (S955).

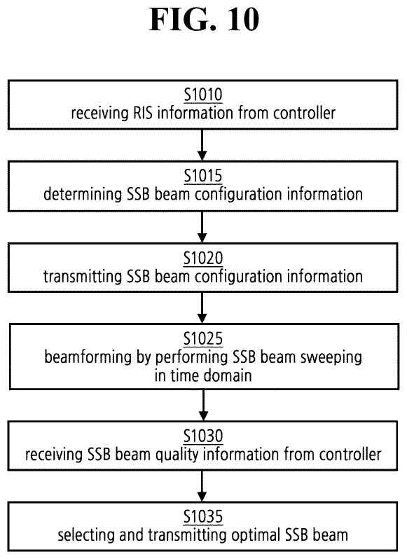

FIG. 10 is a flowchart for describing some embodiments of the operation of the base station in the SSB beam-based beam configuration.

In some embodiments, as illustrated in FIG. 10, the base station may receive RIS information from the RIS controller (S1010). In some embodiments, the RIS information may include at least one of the location information of the RIS and the area information of the RIS.

In some embodiments, as illustrated in FIG. 10, the base station may calculate the distance to the RIS based on the received information to determine the beam transmission power and beam steering direction, and determine the beamwidth based on the area information, designing thereby the SSB beam RIS configuration for the RIS (S1015).

In some embodiments, as illustrated in FIG. 10, the base station may transmit SSB beam configuration information to the RIS controller (S1020).

In some embodiments, as illustrated in FIG. 10, the base station may configure SSB beams based on the previously calculated beamwidth, beam steering direction, and beam transmission power, and start beam sweeping by transmitting SSB beams at different times in the time domain (S1025).

In some embodiments, as illustrated in FIG. 10, the base station may receive SSB beam quality information from the RIS controller (S1030). In some embodiments, the SSB beam quality information may include an SSB index of each SSB beam sweeping in the time domain, and signal quality information corresponding to the respective beam (i.e., the quality information of the signal that is reflected by the RIS and received by the signal measuring device, such as RSRP, RSRQ, RSSI).

In some embodiments, as illustrated in FIG. 10, the base station may select the optimal SSB beam for the RIS based on the received SSB beam quality information and perform beamforming (S1035).

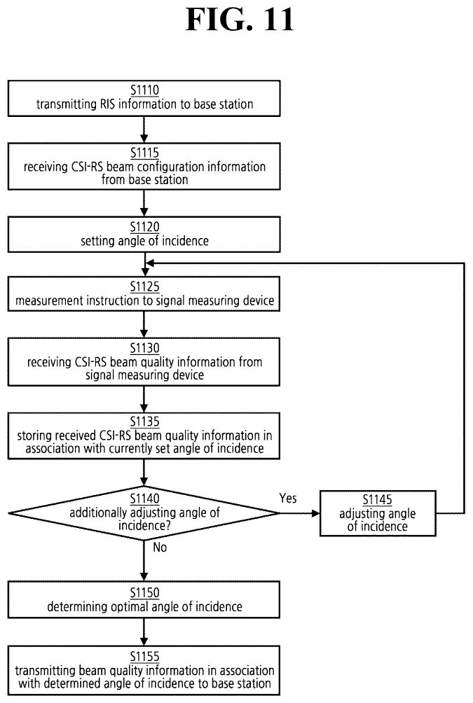

FIG. 11 is a flowchart for describing some embodiments of the operation of the RIS controller in the CSI-RS beam-based beam configuration.

In some embodiments, as illustrated in FIG. 11, the RIS controller may transmit RIS information to the base station (S1110). In some embodiments, the RIS information may include at least one of the location information and the area information of the RIS.

In some embodiments, as illustrated in FIG. 11, the RIS controller may receive CSI-RS beam configuration information from the base station (S1115).

In some embodiments, as illustrated in FIG. 11, the RIS controller may determine and set an initial angle of incidence of the received beam based on the received CSI-RS beam configuration information (S1120). In some embodiments, the angle of incidence of the received beam may be set through direction control of the RIS and/or phase control of the reflecting elements of the RIS.

Referring to FIG. 11, in some embodiments, the RIS controller may transmit CSI-RS configuration information to the signal measuring device and instruct the signal measuring device to measure the signal quality of the reflected beam (S1125). In some embodiments, the signal measuring device may measure and transmit the received signal quality of the reflected beam for each CSI-RS index to the RIS controller based on the CSI-RS beam configuration information.

In some embodiments, as illustrated in FIG. 9, the RIS controller may receive CSI-RS beam quality information from the signal measuring device (S1130). In some embodiments, the CSI-RS beam quality information may include a CSI-RS index of each CSI-RS beam, and signal quality information corresponding to the beam (i.e., the quality information of the signal that is reflected by the RIS and received by the signal measuring device, such as RSRP, RSRQ, RSSI).

In some embodiments, as illustrated in FIG. 11, the RIS controller may store the received CSI-RS beam quality information (e.g., signal quality information for each CSI-RS index) in association with the currently set angle of incidence (S1135).

In some embodiments, as illustrated in FIG. 11, if additional angle of incidence adjustment should be performed (e.g., in a structure capable of adjusting the angle of incidence, the preset number of angle of incidence adjustments has not been reached or measurement for all angles of incidence has not been performed) (S1140), the RIS controller may additionally adjust and set the angle of incidence (S1145) and repeat operations S1125, S1130, and S1135.

Referring to FIG. 11, in some embodiments, if additional adjustment of the angle of incidence of the received beam is not required (S1140), the RIS controller may select the optimal CSI-RS beams by examining the CSI-RS reflected beam reception quality associated with each angle of incidence, and determine the optimal angle of incidence by comparing and evaluating the signal quality of the CSI-RS beams (S1145). The determined angle of incidence can be set as the angle of incidence for receiving the received beam from the base station.

In some embodiments, as illustrated in FIG. 11, if additional angle of incidence adjustment is not necessary (S1140), the RIS controller may determine the optimal angle of incidence based on the CSI-RS beam quality information obtained so far (S1150). For example, when quality measurement for the CSI-RS beam for all angles of incidence is completed, the RIS controller may determine the optimal angle of incidence based on the stored CSI-RS beam quality information for each angle of incidence (e.g., received signal quality information for the reflected beam obtained by reflecting at least one of the CSI-RS beams according to the corresponding angle of incidence).

In some embodiments, as illustrated in FIG. 11, the RIS controller may transmit CSI-RS beam quality information associated with the determined angle of incidence to the base station (S1155).

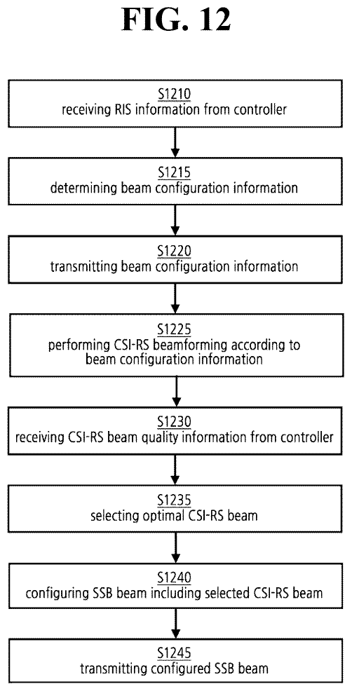

FIG. 12 is a flowchart for describing some embodiments of the operation of the base station in the CSI-RS beam-based beam configuration.

In some embodiments, as illustrated in FIG. 12, the base station may receive RIS information from the RIS controller (S1210). In some embodiments, the RIS information may include at least one of the location information of the RIS and the area information of the RIS.

In some embodiments, as illustrated in FIG. 12, the base station may calculate the distance to the RIS based on the received information to determine the beam transmission power and beam steering direction, and determine the beamwidth based on the RIS area information, thereby designing the CSI-RS beam configuration for the RIS (S1215).

In some embodiments, as illustrated in FIG. 12, the base station may transmit CSI-RS beam configuration information to the RIS controller (S1220).

In some embodiments, as illustrated in FIG. 12, the base station may perform beamforming by configuring CSI-RS beams based on the previously calculated beamwidth, beam steering direction, and beam transmission power (S1225).

In some embodiments, as illustrated in FIG. 12, the base station may receive CSI-RS beam quality information from the RIS controller (S1230). In some embodiments, the CSI-RS beam quality information may include a CSI-RS index of each of CSI-RS beam, and signal quality information corresponding to the beam (i.e., the quality information of the signal that is reflected by the RIS and received by the signal measuring device, such as RSRP, RSRQ, RSSI).

In some embodiments, as illustrated in FIG. 12, the base station may select the optimal CSI-RS beam for the RIS based on the received CSI-RS beam quality information (S1235).

In some embodiments, as illustrated in FIG. 12, the base station may newly configure an SSB beam that includes all of the selected CSI-RS beams (S1240).

In some embodiments, as illustrated in FIG. 12, the base station may perform beamforming including the configured SSB beam (S1245).

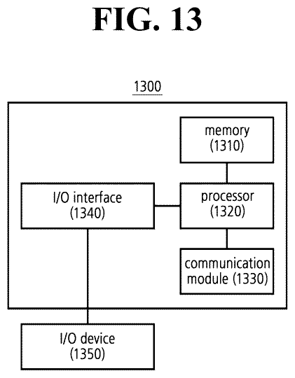

FIG. 13 is a block diagram illustrating an electronic device for performing a method according to embodiments of the present disclosure. In FIG. 13, electronic device 1300 is described as a single physical device, but depending on the embodiment, electronic device 1300 may be implemented as a plurality of devices operating in cooperation (e.g., distributed computing). In some embodiments, electronic device 1300 may include a memory 1310, a processor 1320, and a communication module 1330, as shown in FIG. 13. In some other embodiments, electronic device 1300 may further include an input/output interface 1340 and all or some of other units.

The memory (1310) may be a computer-readable recording medium and may include a RAM (random access memory), a ROM (read only memory), and a non-volatile mass storage device such as a disk drive. Here, the ROM and the non-volatile mass storage devices may be included as separate permanent storage devices apart from the memory (1310). Additionally, the memory (1310) may store an operating system and at least one program code (e.g., a computer program stored on the recording medium included in the electronic device (1300) to control the electronic device (1300) to perform methods according to embodiments of the present disclosure). These software components may be loaded from a computer-readable recording medium separate from the memory (1310). This separate computer-readable recording medium may include floppy drives, disks, tapes, DVD/CD-ROM drives, memory cards, and other computer-readable recording media. In other embodiments, the software components may be loaded into the memory (1310) via the communication module (1330) instead of a computer-readable recording medium.

The processor (1320) may be configured to process instructions of a computer program by performing basic arithmetic, logic, and input/output operations. The instructions may be provided to the processor (1320) by the memory (1310) or the communication module (1330). For example, the processor (1320) may be configured to execute the instructions received according to the program code loaded into the memory (1310). As a more specific example, the processor (1320) can sequentially execute instructions according to the code of a computer program loaded in the memory (1310) to perform beam configuration and/or RIS control according to the embodiments of the present disclosure.

The communication module (1330) may provide functions for communicating with other physical devices over an actual computer network. For example, while the processor (1320) of the electronic device (1300) performs part of the process of the present embodiment, another physical device in the network (e.g., another computing system not shown) can perform the remaining process, and the processing results may be exchanged via the computer network and the communication module (1330) to perform the embodiments of the present disclosure.

The input/output interface (1340) may serve as a means for interfacing with input/output devices (1350). For example, input devices in the input/output devices (1350) may include devices such as a keyboard or a mouse, and output devices may include devices such as a display or speakers. In FIG. 13, the input/output devices (1350) are represented as separate devices from the electronic device (1300), but in some embodiments, the electronic device (1300) may be implemented to include the input/output devices (1350).

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer and may be implemented as various recording media such as a magnetic storage medium, an optical reading medium, and a digital storage medium. Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method for configuring a beam by a base station, comprising the steps of:
determining a beam parameter including at least one of beamwidth, beam steering direction, and beam transmission power, based on at least one of a location and an area of a reflective surface;
generating beam configuration information including at least one beam based on the determined beam parameter and transmitting the beam configuration information to a controller controlling the reflective surface;
forming the at least one beam according to the beam parameter and the beam configuration information;
receiving beam quality information from the controller, the beam quality information including a beam index for each of the formed at least one beam and signal quality information of a reflected beam obtained by reflecting the corresponding beam by the reflective surface; and
adjusting beam formation based on the received beam quality information.

2. The method of claim 1, wherein the determining step comprises:
receiving reflective surface information including information on the location and the area of the reflective surface from the controller; and
determining the beam parameter based on the received reflective surface information.

3. The method of claim 1, wherein the determining step comprises:
estimating a distance between the base station and the reflective surface based on the location of the reflective surface; and
determining the beamwidth, the beam steering direction, and the beam transmission power based on at least a part of the estimated distance, the location of the reflective surface, and the area of the reflective surface.

4. The method of claim 1, wherein:
the beam includes a Synchronization Signal Block (SSB) beam, the forming step includes performing SSB beam sweeping, and the beam index includes an SSB index.

5. The method of claim 4, wherein:
the beam quality information includes signal quality information of reflected beams corresponding to a plurality of SSB beams, respectively, and
the adjusting step comprises:
selecting at least one of the plurality of SSB beams based on the beam quality information; and
adjusting the beam parameters based on the selected at least one SSB beam.

6. The method of claim 1, wherein:
the beam includes a Channel State Information-Reference Signal (CSI-RS) beam, and
the beam index includes a CSI-RS index.

7. The method of claim 6, wherein:
the beam quality information includes signal quality information of reflected beams corresponding to a plurality of CSI-RS beams, respectively, and
the adjusting step comprises:
selecting at least one of the plurality of CSI-RS beams based on the beam quality information; and
adjusting the beam parameters for an SSB beam including the selected at least one CSI-RS beam.

8. The method of claim 7, further comprising:
forming the SSB beam including the selected at least one CSI-RS beam according to the adjusted beam parameters;
receiving feedback information on the selected at least one CSI-RS beam from a user equipment; and
selecting one of the selected at least one CSI-RS beam based on the received feedback information.

9. The method of claim 8, wherein the user equipment comprises a user equipment that has initially accessed the base station based on the SSB beam including the selected at least one CSI-RS beam.

10. The method of claim 1, wherein the reflective surface comprises a Reflective Intelligent Surface.

11. A method for controlling a reflective surface that reflects a beam formed by a base station, the method comprising:
receiving beam configuration information from the base station;
transmitting the beam configuration information to a signal measuring device;
Receiving beam quality information from the signal measuring device, the beam quality information including a beam index for each beam formed by the base station and signal quality information of a reflected beam obtained by reflecting the corresponding beam by the reflective surface; and
transmitting the received beam quality information to the base station.

12. The method of claim 11, further comprising transmitting reflective surface information including information on a location and an area of the reflective surface to the base station.

13. The method of claim 11, further comprising setting an initial angle of incidence of the reflective surface based on the received beam configuration information.

14. The method of claim 13, further comprising:
instructing the signal measuring device to measure beam quality; and
adjusting the angle of incidence of the reflective surface based on the received beam quality information,
wherein the receiving step includes storing the received beam quality information in association with a currently set angle of incidence, and
the instructing step, the receiving step, and the adjusting step are repeated until beam quality information for a plurality of angles of incidence is obtained.

15. The method of claim 14, wherein the instructing step, the receiving step, and the adjusting step are repeated until beam quality information for all settable angles of incidence of the reflective surface is obtained.

16. The method of claim 14, further comprising:
selecting one of the plurality of angles of incidence based on the obtained beam quality information for each of the plurality of angles of incidence, and setting the angle of incidence of the reflective surface to the selected angle of incidence; and
transmitting the beam quality information associated with the selected angle of incidence to the base station.

17. The method of claim 11, wherein the beam includes an SSB beam, the beam is formed by SSB beam sweeping, and the beam index includes an SSB index.

18. The method of claim 11, wherein the beam includes a CSI-RS beam, and the beam index includes a CSI-RS index.

19. A base station comprising:
a processor;
at least one hardware-based transceivers; and
a computer-readable storage medium containing instructions, which, in response to execution by the processor, cause the base station to perform the method as claimed in claim 1.
